(19) United States
(12) Patent Application Publication
(10) Pub. No.: US 2024/0241573 A1
(43) Pub. Date: Jul. 18, 2024

(54) FULL BODY MOTION TRACKING FOR USE IN VIRTUAL ENVIRONMENT

(71) Applicant: Meta Platforms Technologies, LLC, Menlo Park, CA (US)

(72) Inventors: Albert Pumarola Peris, Kilchberg (CH); Yuming Du, London Colney (GB); Robin Kips, Zurich (CH); Wolfram Sebastian Starke, London (GB); Ali Thabet, Zurich (CH); Artsiom Sanakoyeu, Zurich (CH)

(21) Appl. No.: 18/411,623

(22) Filed: Jan. 12, 2024

Related U.S. Application Data
(60) Provisional application No. 63/479,924, filed on Jan. 13, 2023.

(51) Int. Cl. G06F 3/01; G06F 3/0346

(52) U.S. Cl. CPC G06F 3/011; G06F 3/0346

(57) ABSTRACT

A method for full body motion tracking includes receiving tracking signals from a plurality of sensors associated with an upper body of a person, and based on the tracking signals, determining motion features and joint features. The method further includes training a diffusion model that includes a multi-layer perceptron (MLP) network, and generating a multiple inputs to the trained diffusion model, the inputs including the motion features and the joint features. The method includes providing the inputs to the trained diffusion model to generate multiple outputs. The outputs include sequences of full body poses, the sequences of full body poses including upper body poses and lower body poses.

### CROSS-REFERENCE OF RELATED APPLICATION

This application claims the benefit of U.S. Provisional Application No. 63/479,924, filed on Jan. 13, 2023, which is incorporated herein in its entirety.

### TECHNICAL FIELD

The present disclosure generally relates to accurately tracking full body motions for realistic control of full body avatars in a virtual environment and, more particularly, tracking full bodies given sparse upper body tracking signals.

### BACKGROUND

Movement of avatars in augmented reality (AR)/virtual reality (VR) applications are typically dictated by movements of a user tracked in the real-world via Inertial Measurement Unit (IMU) sensors in a head mounted device (HMD) and/or handheld devices. Full body motion tracking is desirable, as it provides engaging experiences where users can interact with the virtual environment with an increased sense of presence.

A particular challenge with full body motion tracking is that tracking signals available from standalone HMDs is often limited to tracking the user's head and wrist. While this signal may be resourceful for reconstructing upper body motion, the lower body is not directly tracked. Any lower body tracking solution using additional tracking signals (e.g., additional IMUs) from lower body joints and application to the avatars movement in the AR/VR application would come at a higher cost, lower accuracy, and at the expense of the user's comfort. Existing approaches to full body motion tracking rely on more than 3 inputs and/or struggle to predict full body pose, and lower body pose in particular.

With user motion tracking being the primary source for avatar manipulation in AR/VR applications, there is a need for improving motion tracking accuracy, and more specifically, providing full body motion tracking.

### SUMMARY

According to some embodiments, a method for full body motion tracking includes receiving tracking signals from a group of sensors associated with an upper body of a person, and based on the tracking signals, determining motion features and joint features. The method further includes training a diffusion model, the diffusion model comprising a multi-layer perceptron (MLP) network, and generating a group of inputs to the trained diffusion model, the group of inputs comprising the motion features and the joint features. The method further includes providing the group of inputs to the trained diffusion model to generate a group of outputs. The group of outputs include sequences of full body poses, and the sequences of full body poses include upper body poses and lower body poses.

According to some embodiments, a non-transitory computer-readable medium stores a program for full body motion tracking, which when executed by a computer, configures the computer to receive tracking signals from a group of sensors associated with an upper body of a person, and based on the tracking signals, determine motion features and joint features. The program, when executed, further configures the computer to train a diffusion model, the diffusion model comprising a multi-layer perceptron (MLP) network, to generate a group of inputs to the trained diffusion model, the group of inputs comprising the motion features and the joint features, and to provide the group of inputs to the trained diffusion model to generate a group of outputs. The group of outputs include sequences of full body poses, and the sequences of full body poses include upper body poses and lower body poses.

According to some embodiments, a system for full body motion tracking includes a processor and a non-transitory computer readable medium storing a set of instructions, which when executed by the processor, configure the processor to receive tracking signals from a group of sensors associated with an upper body of a person, and based on the tracking signals, determine motion features and joint features. The instructions, when executed, further configure the processor to train a diffusion model, the diffusion model comprising a multi-layer perceptron (MLP) network, to generate a group of inputs to the trained diffusion model, the group of inputs comprising the motion features and the joint features, and to provide the group of inputs to the trained diffusion model to generate a group of outputs. The group of outputs include sequences of full body poses, and the sequences of full body poses include upper body poses and lower body poses.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement full body motion tracking, according to some embodiments.

FIG. 2 is a block diagram illustrating details of devices used in the architecture of FIG. 1, according to some embodiments.

FIG. 3 is a flowchart illustrating a process for full body motion tracking, according to some embodiments.

FIG. 4 illustrates an example of full body motion synthesis using a diffusion model, according to some embodiments.

FIG. 5 is a block diagram illustrating an MLP-based network according to some embodiments.

FIG. 6 is a block diagram illustrating an MLP-based diffusion model according to some embodiments.

FIG. 7. shows a qualitative comparison between the diffusion model 600 of some embodiments and AvatarPoser.

FIG. 8 shows a visualization of motion trajectory between the diffusion model 600 of some embodiments and AvatarPoser.

FIG. 9 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The term “virtual reality” as used herein refers, according to some embodiments, to a computer-generated simulation of an immersive, two-dimensional or (more typically) three-dimensional environment that can be explored and interacted with by individuals through sensory stimuli, typically employing headsets or other specialized devices. Virtual reality (abbreviated as “VR”) may provide a sensory-rich experience that simulates and/or replicates the real world or an imagined setting, enabling users to engage in activities, manipulate objects, and perceive a simulated environment as if it were real. VR systems often encompass visual, auditory, and/or haptic feedback to enhance the sense of presence and immersion, transporting users into a digitally generated world where they can interact, learn, or experience various scenarios in a highly immersive and interactive manner. As used herein, the term “virtual reality” is understood to include the Internet and “augmented reality.”

The term “diffusion model” as used herein refers, according to some embodiments, to a type of likelihood-based generative model that learns to reverse random Gaussian noise added by a Markov chain in order to recover desired data samples from the noise. Diffusion models may require step embedding to be injected in the network during training and inference stages of the model.

The term “full body motion tracking” as used herein refers, according to some embodiments, to technology that captures and interprets the movements and positions of an individual's entire body in real time. This technology utilizes a combination of sensors, cameras, and/or other tracking devices to collect data on the user's movements, including joint angles, limb positions, and gestures. After comprehensively capturing these movements, they are reconstructed and translated into digital representations, allowing for accurate mapping of the user's body movements onto an avatar or virtual character within a digital environment. This technology enables immersive experiences in virtual reality (VR), augmented reality (AR), gaming, sports analysis, healthcare, and various other applications by precisely tracking and replicating the user's physical actions in a digital space. Full body motion tracking may be equivalently referred to herein as “full body motion synthesis” or “full body motion prediction.”

Some embodiments of the present disclosure provide, as a technical solution to the technical problems described above, a model to track full body motion (including upper and lower body motion) given only sparse upper body tracking signals, and provide accurate pose predictions, particularly for lower bodies. For example, some embodiments enable high-fidelity full body tracking using only the standard three inputs (head and hands) provided by most HMDs. The model may be more robust against tracking signal loss than existing approaches to motion prediction.

For example, the model may use a multi-layer perceptron (MLP) architecture and a conditioning scheme for motion data to predict accurate and smooth full body motion, specifically lower body movement. The model may include a compact architecture to generate realistic smooth motions while achieving real-time inference speed, making it usable for online body-tracking applications (such as AR/VR applications).

According to some embodiments, the model may be a conditional diffusion model. A timestep embedding may be injected during the diffusion process to mitigate jittering issues and improve the model performance and robustness to the loss of tracking signal. The timestep embedding may implement a block-wise injection scheme that adds diffusion timestep embedding before every intermediate block of a neural network (NN). This injection scheme enables gradual denoising and the production of smooth motion sequences.

Given a sequence of N observed joint features, some embodiments include predicting whole body poses from N observed joint frames based on input/output joint features. The diffusion model may be a conditional model configured to generate sequences of full body poses conditioned on the sparse tracking of the observed joint features. In other words, the diffusion model of some embodiments may predict body poses. The diffusion model may leverage an MLP-based network for full body motion synthesis based on sparse tracking signals, such that each block M of the MLP network contains both a convolutional layer and a fully connected layer, which are responsible for merging of temporal and spatial information, respectively.

In some embodiments, motion features and the observed joint features at time t may be separately passed through the fully connected layer to obtain intermediate features. The intermediate features for the N frames may be concatenated and fed to the MLP network. Embedding of the timestep t may be repetitively injected before every block M of the MLP network, instead of as an extra input to the network (for example, by concatenating the embedding to the joint features). The timestep embedding may be projected to match dimensions of the input joint features and passed through a fully connected layer and a sigmoid linear unit (SiLU) activation layer of the MLP network. Subsequently, the obtained intermediate features may be directly added to input intermediate activations. In this manner, the diffusion model according to embodiments can largely mitigate jittering issues and enables synthesis of smooth motions to be applied to an online avatar.

In some implementations, the N observed joint frames may be set to 196 joint frames (i.e., N=196) and joint rotations may be represented by a 6D reparameterization. The MLP network may be comprised of 12 blocks (i.e., M=12). The diffusion model may be trained using two settings to predict the global orientation of a root joint and relative rotation of other joints. During inference, the diffusion model may be applied auto-regressively for the longer sequences.

Some embodiments provide a computer-implemented method that includes receiving motion data from a sensor regarding an augmented reality (AR)/virtual reality (VR) device, the motion data representing sparse tracking signals; generating a model for predicting full body poses, the model containing a multi-layer network; determine motion features and joint features from the motion data; obtain intermediate features using the model based on the motion features and the joint features; generate sequences of full body poses based on the intermediate features; and estimating a user's legs position based on the sequences of full body poses.

Some embodiments provide a non-transitory computer-readable medium that stores instructions that, when executed by a processor, cause the processor to perform a method that includes receiving motion data from a sensor regarding an augmented reality (AR)/virtual reality (VR) device, the motion data representing sparse tracking signals; generating a model for predicting full body poses, the model containing a multi-layer network; determine motion features and joint features from the motion data; obtain intermediate features using the model based on the motion features and the joint features; generate sequences of full body poses based on the intermediate features; and estimating a user's legs position based on the sequences of full body poses.

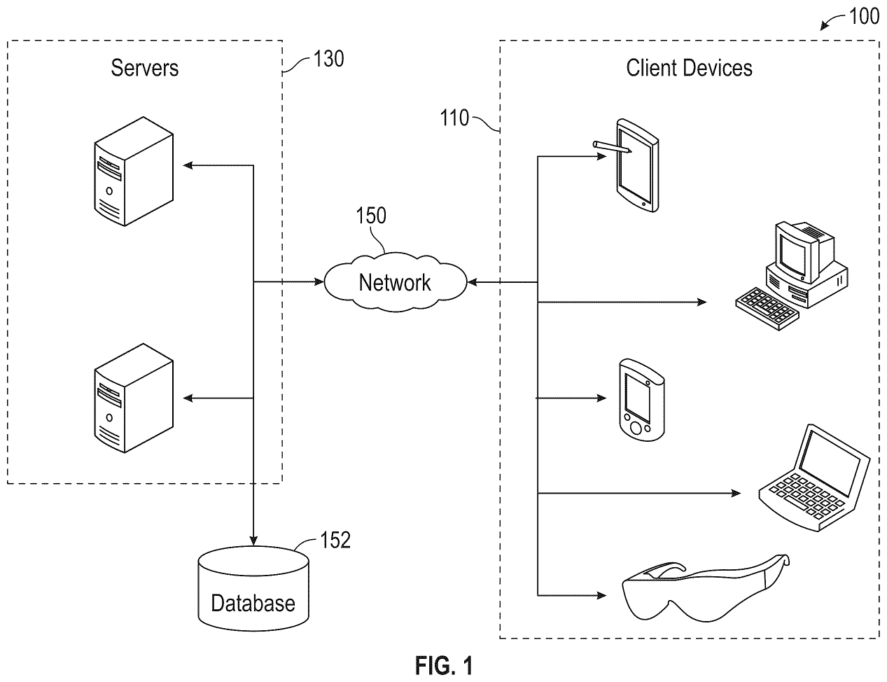

FIG. 1 illustrates a network architecture 100 used to implement full body motion tracking, according to some embodiments. Architecture 100 may include servers 130 and a database 152, communicatively coupled with multiple client devices 110 via a network 150. Client devices 110 may include any one of a laptop computer, a desktop computer, or a mobile device such as a head-mounted device (HMD), smart phone, a palm device, video player, or a tablet device. The database 152 may store backup files from, for example, matrices, videos, and processing data.

Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

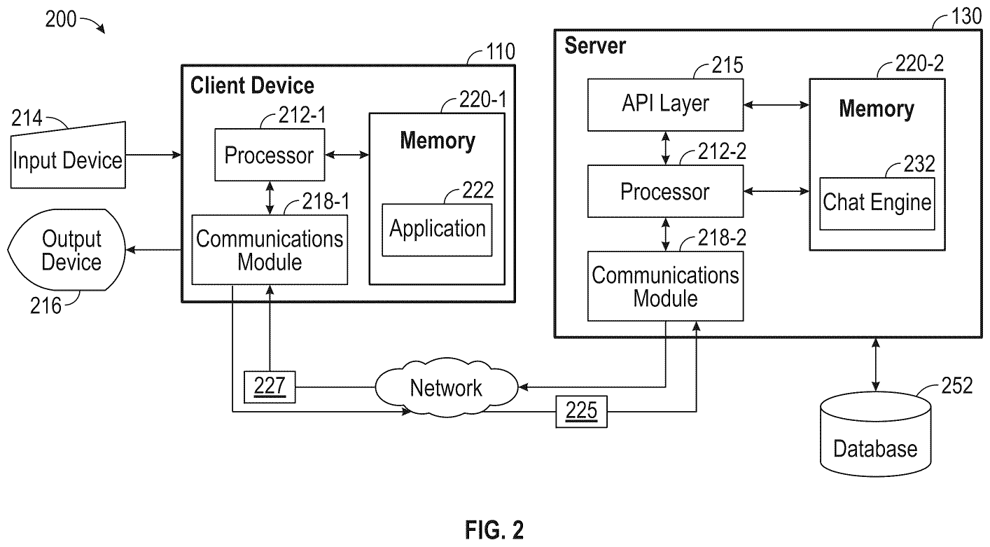

FIG. 2 is a block diagram illustrating details of a system 200 having at least one client device 110 and at least one server 130 used in a network architecture as disclosed herein (e.g., architecture 100), according to some embodiments. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as requests, uploads, messages, and commands to other devices on the network 150. Communications modules 218 can be, for example, modems or Ethernet cards, and may include radio hardware and software for wireless communications (e.g., via electromagnetic radiation, such as radiofrequency -RF-, near field communications -NFC-, Wi-Fi, and Bluetooth radio technology). Client device 110 may be coupled with an input device 214 and with an output device 216. A user may interact with client device 110 via the input device 214 and the output device 216. Input device 214 may include a mouse, a keyboard, a pointer, a touchscreen, a microphone, a joystick, a virtual joystick, a touch-screen display that a user may use to interact with client device 110, or the like. In some embodiments, input device 214 may include cameras, microphones, and sensors, such as touch sensors, acoustic sensors, inertial motion units -IMUs- and other sensors configured to provide input data to a VR/AR headset. Output device 216 may be a screen display, a touchscreen, a speaker, and the like.

Client device 110 may also include a processor 212-1, configured to execute instructions stored in a memory 220-1, and to cause client device 110 to perform at least some operations in methods consistent with the present disclosure. Memory 220-1 may further include an application 222, configured to run in client device 110 and couple with input device 214 and output device 216. The application 222 may be downloaded by the user from server 130 and may be hosted by server 130. The application 222 includes specific instructions which, when executed by processor 212-1, cause operations to be performed according to methods described herein. In some embodiments, the application 222 runs on an operating system (OS) installed in client device 110. In some embodiments, application 222 may run out of a web browser. In some embodiments, the processor is configured to control a graphical user interface (GUI) for the user of one of client devices 110 accessing the server 130.

A database 252 may store data and files associated with the server 130 from the application 222. In some embodiments, client device 110 is a mobile phone used to collect a video or picture and upload to server 130 using a video or image collection application 222, to store in the database 252.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes an application engine 232. The application engine 232 may be configured to perform operations and methods according to aspects of embodiments. The application engine 232 may share or provide features and resources with the client device, including multiple tools associated with data, image, or video collection, capture, or applications that use data, images, or video retrieved with application engine 232 (e.g., application 222). The user may access application engine 232 through application 222, installed in a memory 220-1 of client device 110. Accordingly, application 222 may be installed by server 130 and perform scripts and other routines provided by server 130 through any one of multiple tools. Execution of application 222 may be controlled by processor 212-1.

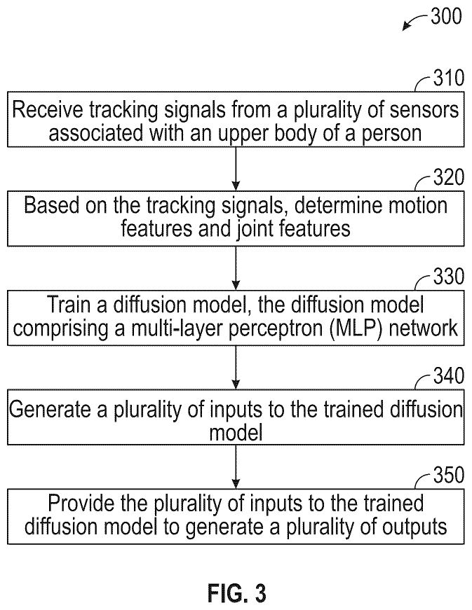

FIG. 3 is a flowchart illustrating a process 300 for full body motion tracking, performed by a server (e.g., server 130, etc.) or a device (e.g., client device 110, etc.), according to some embodiments. In some embodiments, one or more operations in process 300 may be performed by a processor circuit (e.g., processors 212, etc.) executing instructions stored in a memory circuit (e.g., memories 220, etc.) of a system (e.g., system 200) as disclosed herein. Moreover, in some embodiments, a process consistent with this disclosure may include at least operations in process 300 performed in a different order, simultaneously, quasi-simultaneously, or overlapping in time.

At 310, the process 300 receives tracking signals from a plurality of sensors associated with an upper body of a person. In some embodiments, the plurality of sensors include, but are not limited to, inertial measurement units (IMUs). The sensors may be mounted to upper body devices, such as a head mounted device (HMD) or handheld devices. For example, the sensors may be located in an HMD and two handheld devices, one in each of the person's hands. The tracking signals may include, but are not limited to, orientation and translation of each of the devices.

At 320, the process 300 determines motion features and joint features based on the tracking signals.

At 330, the process 300 trains a diffusion model, that includes a multi-layer perceptron (MLP) network. In some embodiments, the MLP network includes multiple blocks. Each of the blocks may include a convolutional layer and a fully connected layer. Each block may further include a sigmoid linear unit activation layer and a layer normalization.

At 340, the process 300 generates multiple inputs to the trained diffusion model. The multiple inputs may include the motion features and the joint features. In some embodiments, the inputs to the diffusion model also include intermediate features generated from the motion features and the joint features.

In some embodiments, the MLP network includes multiple blocks, and the process 300 provides a timestep embedding to each block. For example, the timestep embedding may be provided to each block through a fully connected layer and a sigmoid linear unit activation layer.

At 350, the process 300 provides the multiple inputs to the trained diffusion model to generate multiple outputs. In some embodiments, the outputs include sequences of full body poses. The sequences of full body poses include upper body poses and lower body poses.

In some embodiments, the outputs may also include positions of a lower body of the person. The process 300 may also include estimating the positions of the lower body based on the sequences of full body poses.

In some embodiments, the outputs are generated from the MLP network based on the intermediate features. For example, the sequences of full body poses may be generated based on the intermediate features.

### Experimental Methods

### Problem Formulation

Some embodiments predict the whole-body motion given sparse tracking signals, i.e. the orientation and translation of a headset and two hand controllers. Given a sequence of N observed joint features p^{1:N}={pⁱ}ᵢ₌₁^{N}∈ [symbol] ^{N×C}, it is desired to predict the whole body poses for the N frames [symbol] ^{1:N}={ [symbol] ⁱ}ᵢ₌₁^{N}∈ [symbol] ^{N×S}, where C and S represent the dimension of the input/output joint features. In this example, a skinned multi-person linear model (SMPL) model was used to represent the human poses, using only the first 22 joints of the SMPL model and ignoring the joints on the hands. Thus, [symbol] ^{1:N} represents the global orientation of the pelvis and the relative rotation of each joint.

Some of the following examples use a simple MLP-based network for full body motion synthesis based on sparse tracking signals. The performance may be further improved by leveraging the proposed MLP-based architecture to power a conditional generative diffusion model, referred to as “Avatars Grow Legs” (AGRoL).

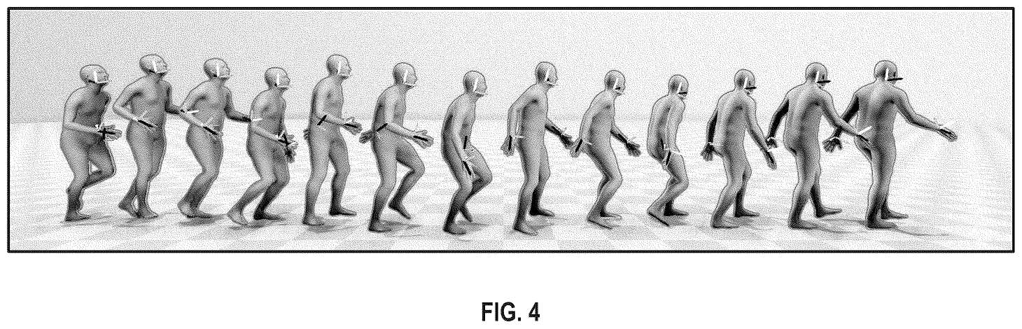

FIG. 4 illustrates an example of full body motion synthesis based on HMD and hand controllers input using a diffusion model, according to some embodiments. RGB axes illustrate the orientation of the head and hands which serves as the input to the model.

### MLP-Based Network

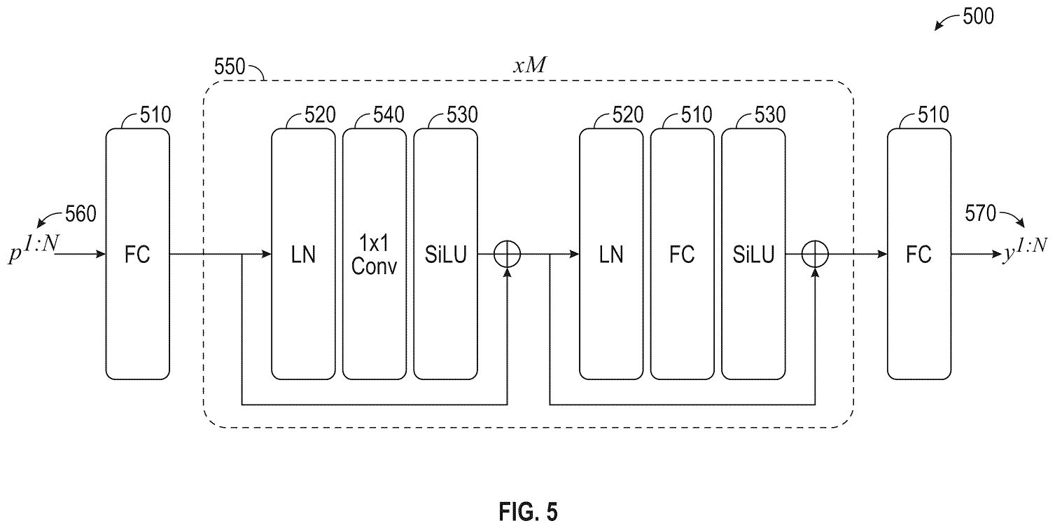

FIG. 5 is a block diagram illustrating an MLP-based network 500 according to some embodiments. In this example, the MLP-based network 500 is composed of only 4 types of components: fully connected layers, a SiLU activation layer, a 1D convolutional layer with kernel size 1, and layer normalization. FC, LN, and SiLU denote fully connected (FC) layers 510, layer normalizations 520, and SiLU activation layers 530 respectively. 1×1 Conv denotes a 1D convolution layer 540 with kernel size 1. Note that 1×1 Conv here is equivalent to a fully connected layer operating on the first dimension of an input tensor [symbol] ^{N×\hat{D}}, while the FC layers operate on the last dimension. N denotes the temporal dimension and \hat{D} denotes the dimension of the latent space.

Each middle block 550 of the MLP-based network 500 contains one convolutional layer 540 and one fully connected (FC) layer 510, which is responsible for temporal and spatial information merging respectively. In this example, the middle block 550 is repeated M times.

Some embodiments use skip-connections as pre-normalization of the layers. The first layer of the MLP-based network 500 (an FC layer 510) projects input data 560 (denoted p^{1:N}) to a latent space [symbol] ^{N×\hat{D}} and the last layer (an FC layer 510) converts from the latent space to an output space of full body poses [symbol] ^{N×S} (e.g., output data 570, denoted [symbol] ^{1:N}).

### Diffusion Model

A diffusion model is a type of generative model which learns to reverse random Gaussian noise added by a Markov chain in order to recover desired data samples from the noise.

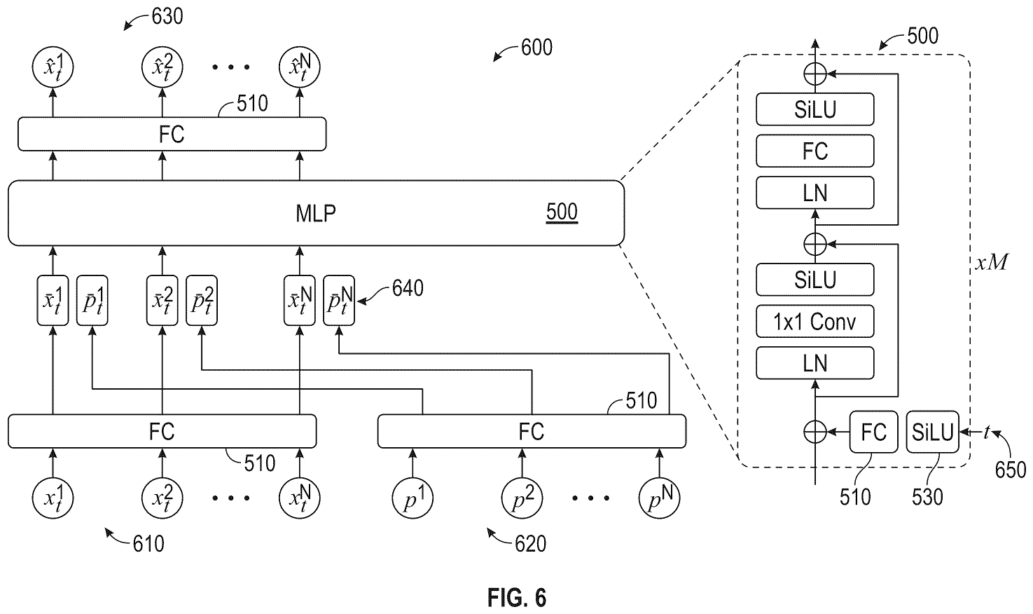

FIG. 6 is a block diagram illustrating an MLP-based diffusion model 600 according to some embodiments. The diffusion model 600 includes an MLP-based network, e.g., MLP-based network 500, and FC layers 510 at the input and output. In this example, t is the noising step, and the inputs 610 (denoted by xₜ^{1:N}) represent a motion sequence of length N at step t, which may be pure Gaussian noise when t=0. The inputs 620 (denoted by p^{1:N}) represent the sparse upper body signals of length N. The outputs 630 (denoted by \hat{x}ₜ^{1:N}) represent the denoised motion sequence at step t.

In the forward diffusion process, given a sample motion sequence x₀^{1:N}˜q(x₀^{1:N}) from the data distribution, the Markovian noising process can be written as:

$$\\ \begin{matrix}q ( {x}_{t}^{{}_{} 1 : N} \vert {x}_{t - 1}^{{}_{} 1 : N} ) := N ( {x}_{t}^{{}_{} 1 : N} ; \sqrt{{a}_{t}} {x}_{t - 1}^{{}_{} 1 : N} , ( 1 - {a}_{t} ) I ) , & ( 1 )\end{matrix}$$

where αₜ∈(0,1)∈(0, 1) is constant hyper-parameter and I is the identity matrix. x_{T}^{1:N} tend to an isotropic Gaussian distribution when t→∞. Then, in the reverse diffusion process, a model p_{θ} with parameters θ is trained to generate samples from a Gaussian noise input x_{T}˜N(0,1) with a fixed variance σₜ². Formally,

$$\\ \begin{matrix}{p}_{θ} ( {x}_{t - 1}^{{}_{} 1 : N} \vert {x}_{t}^{{}_{} 1 : N} ) := N ( {x}_{t - 1}^{{}_{} 1 : N} ; {μ}_{θ} ( {x}_{t} , t ) , {σ}_{t}^{{}_{} 2} I ) , & ( 2 )\end{matrix}$$

where μ_{θ} could be reformulated as,

$$\\ \begin{matrix}{μ}_{θ} ( {x}_{t} , t ) = \frac{1}{\sqrt{{a}_{t}}} ( {x}_{t} - \frac{1 - {a}_{t}}{1 - {a}_{t}} ) {ϵ}_{θ} ( {x}_{t} , t ) ) , & ( 3 )\end{matrix}$$

where āₜ=α₁ . . . aₜ. So, the diffusion model 600 has to learn to predict noise ϵ_{θ}(xₜ, t) from xₜ and timestep t.

It is desirable to use the diffusion model 600 to generate sequences of full body poses conditioned on the sparse tracking of joint features p^{1:N}. Thus, the reverse diffusion process becomes conditional: p_{θ}(xₜ₋₁^{1:N}|xₜ^{1:N}, p^{1:N}). Moreover, the clean body poses \hat{x}₀^{1:N} are directly predicted instead of predicting the residual noise ∈_{θ}(xₜ,t). The output of the model f_{θ} is denoted by \hat{x}₀^{1:N}=f_{θ}(x^{1:N},p^{1:N},t). The objective function may then be formulated as

$$\\ \begin{matrix}{ℒ}_{dm} = {𝔼}_{{x}_{0}^{1 : N} \sim q ( {x}_{0}^{1 : N} ) , t} [ {‖ {x}_{0}^{{}_{} 1 : N} - {f}_{θ} ( {x}^{{}_{} 1 : N} , {p}^{{}_{} 1 : N} , t ) ‖}_{2}^{2} ] . & ( 4 )\end{matrix}$$

As shown in the example of FIG. 6, some embodiments use the MLP-based network 500 described above as the model f_{θ} that predicts the full body poses. At time step t, the motion features xₜ^{1:N} and the observed joints feature p^{1:N} are first passed separately through fully connected (FC) layers 510 to obtain the intermediate features 640, denoted by x̅ₜ^{1:N} and p̅^{1:N} and defined as:

$$\\ \begin{matrix}\overline{x} {}_{t}^{{}_{} 1 : N} = {FC}_{0} ( {x}_{t}^{{}_{} 1 : N} ) & ( 5 )\end{matrix}$$

$$\\ \begin{matrix}\overline{p} {}^{{}_{} 1 : N} = {FC}_{1} ( {p}^{{}_{} 1 : N} ) & ( 6 )\end{matrix}$$

These intermediate features 640 may be concatenated together and fed to the MLP-based network 500.

$$\\ \begin{matrix}\hat{x} {}_{0}^{{}_{} 1 : N} = {f}_{θ} ( Concat ( \overline{x} {}_{t}^{{}_{} 1 : N} , \overline{p} {}^{{}_{} 1 : N} ) , t ) & ( 7 )\end{matrix}$$

Block-wise Timestep Embedding. In some diffusion models, embedding of the timestep t is fed to a network as an extra input. However, as some embodiments use MLPs, the diffusion model 600 may not be sensitive to the values of the timestep embedding, which hinders learning the denoising process and results in predicting motions with severe jittering issues, as shown below (See “Experiments”).

To solve this problem, some embodiments repetitively inject a time step embedding 650 before every block of the MLP network, as shown in the example of FIG. 6. The timestep embedding is projected to match the input feature dimensions through a fully connected (FC) layer 510 and a SiLU activation layer 530, and the resulting feature is directly added to the input intermediate activations. As shown below (See “Experiments”), the proposed strategy can largely mitigate the jittering problem and enables synthesis of smooth motions.

### EXPERIMENTS

Embodiments of the diffusion model 600 were trained and evaluated on the AMASS dataset. Two settings were used for training and testing to compare with previous techniques. For the first setting, three subsets were used, CMU, BMLr, and HDM05. For the second setting, a data split was used, with CMU, MPI Limits, Total Capture, Eyes Japn, KIT, BioMotion-Lab, BMLMovi, EKUT, ACCAD, MPI Mosh, SFU, and HDM05 as training data, and HumanEval and Transition as testing data. In both settings, the SMPL human model was adopted for the human pose representation and the diffusion model 600 was trained to predict the global orientation of the root joint and relative rotation of the other joints.

### Implementation Details

The joint rotations were represented by a 6D reparametrization for simplicity and continuity. Thus, for the sequences of body poses y^{1:N}∈ [symbol] ^{N×S}, S=22×6. The frame number was set to N=196 if not stated otherwise.

MLP Network. In this example, the MLP-based network 500 was built using 12 blocks (M=12). All latent features in the MLP-based network 500 had the same shape of N×512. The network was trained with batch size 256 and the Adam optimizer. The learning rate was set to 3e-4 at the beginning and dropped to 1e-5 after 200,000 iterations. The weight decay was set to 1e-4 for the entire training. During inference, the diffusion model 600 was applied in an auto-regressive manner for the longer sequences.

MLP-based Diffusion Model (AGROL). The architecture of the MLP-based network 500 was kept unchanged in the diffusion model 600. To inject the time step embedding used in the diffusion process in the network, in each MLP block, the time step embedding 650 was passed to a fully connected (FC) layer 510 and a SiLU activation layer 530 and added with the input feature. The network was trained with exactly the same hyperparameters as the MLP-based network 500, with the exception of using the AdamW optimizer. The sampling step was set to 1000 with a cosine noise schedule during the training. The DDIM technique was used to speed up the sampling and only sample 5 steps during the inference.

All experiments were conducted with Pytorch frame-work on a single NVIDIA V100 graphics card.

TABLE 1

| Technique | MPJRE | MPJPE | MPJVE | Hand PE | Upper PE | Lower PE | Root PE | Root RE | Jitter | Upper Jitter | Lower Jitter |
|---|---|---|---|---|---|---|---|---|---|---|---|
| Final IK | 16.77 | 18.9 | 59.24 | — | — | — | — | — | — | — | — |
| LoBSTr | 10.69 | 9.02 | 44.97 | — | — | — | — | — | — | — | — |
| VAE-HMD | 4.11 | 6.83 | 37.99 | — | — | — | — | — | — | — | — |
| AvatarPoser* | 3.8 | 4.18 | 27.70 | 2.12 | 1.81 | 7.59 | 3.34 | 19.68 | 14.49 | 7.36 | 24.81 |
| MLP | 2.80 | 4.23 | 25.34 | 3.29 | 2.14 | 7.24 | 3.33 | 19.60 | 14.72 | 9.4 | 20.6 |
| AGRoL | 2.71 | 4.11 | 21.61 | 2.26 | 2.9 | 7.04 | 3.53 | 19.54 | 7.27 | 5.87 | 9.26 |
| GT | 0 | 0 | 0 | 0 | 0 | 0 | 0 | 0 | 4.00 | 3.65 | 4.52 |

Table 1 provides a comparison of the approach of some embodiments with state-of-the-art techniques on a subset of the AMASS dataset. Table 1 reports MPJPE [cm], MPJRE [deg], MPJVE [cm/s], and Jitter [10² m/s³] metrics. In this example, AGROL was found to achieve the best performance on MPJPE, MPJRE and MPJVE, and outperformed other models, especially on the Lower PE (Lower body Position Error) and Jitter metrics, which shows that in this example, the diffusion model 600 generates accurate lower body movement and smooth motions. The best results are in bold, and the second-best results are underlined.

TABLE 2

| Technique | MPJRE | MPJPE | MPJVE | Root RE | Jitter |
|---|---|---|---|---|---|
| VAE-HMD^{†} | — | 7.45 | — | — | — |
| HUMOR^{†} | — | 5.50 | — | — | — |
| FLAG^{†} | — | 4.96 | — | — | — |
| AvatarPoser* | 4.70 | 6.38 | 34.05 | 33.72 | 10.21 |
| MLP | 4.33 | 6.66 | 33.87 | 33.58 | 21.74 |
| AGRoL | 4.30 | 6.59 | 27.63 | 32.95 | 8.20 |
| GT | 0 | 0 | 0 | 0 | 2.93 |

Table 2 provides a comparison of the approach of some embodiments with state-of-the-art techniques on the AMASS dataset. Table 2 reports the MPJPE [cm], MPJRE [deg], MPJVE [cm/s], and Jitter [10² m/s³] metrics. The * denotes that the Avatar-Poser was retrained using public code. The † denotes techniques that use pelvis location and rotation during inference, which may not be directly comparable, as some embodiments assume that the pelvis information is not available during the training and the testing. The best results are in bold, and the second-best results are underlined.

### Evaluation Metrics

In this example, 10 metrics were used to evaluate the diffusion model 600. The metrics can be divided into three types. The first type is rotation-related metrics, which includes the MPJRE (Mean Per Joint Rotation Error [degrees]) and Root RE (Root Rotation Error [degrees]), which measure the average relative rotation error of all joints and the global rotation error of the root joint. The second type is velocity-related metrics including MPJVE (Mean Per Joint Velocity Error[cm/s]) and Jitter, MPJVE (Mean Per Joint Velocity Error[cm/s]) measures the average velocity error of all joints, Jitter measures the mean jerk (time derivative of acceleration) of all body joints in the global space in 10² m/s, which reflects the smoothness of the motion. The third type is position-related metrics, which includes all the rest metrics. Specifically, MPJPE (Mean Per Joint Position Error[cm]) measures the average position error of all joints. Root PE evaluates the position error of the root. Hand PE measures the average position error for the two hands. Upper PE and Lower PE evaluate the average position error for joints in the upper body and lower body respectively.

### Evaluation Results

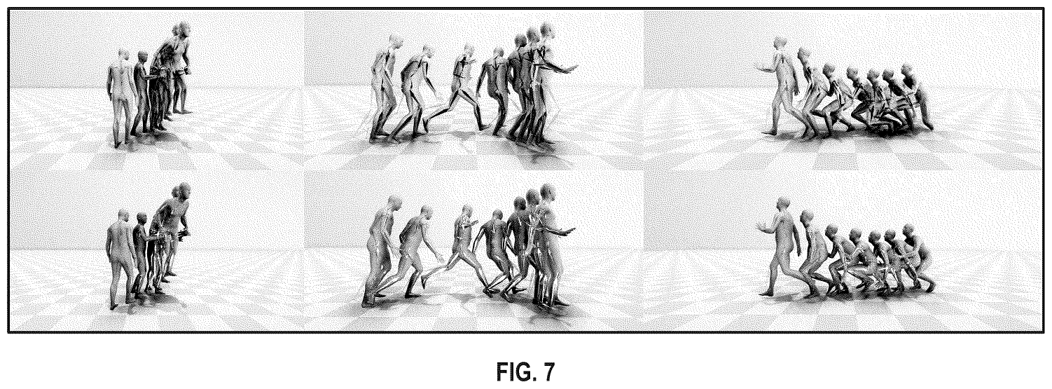

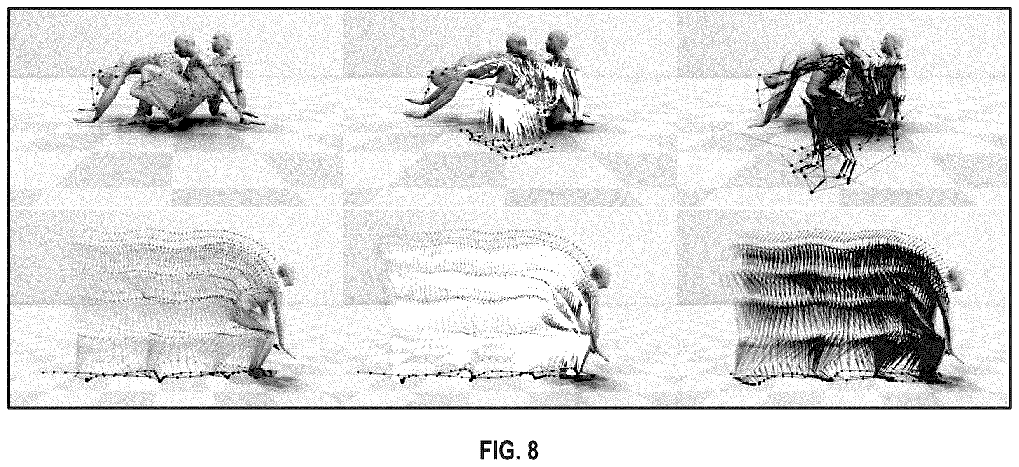

In this example, the diffusion model 600 was evaluated on the AMASS dataset with two different protocols. As shown in Table 1 and Table 2, the MLP-based network 500 surpassed most previous techniques and achieved comparable results, which shows the effectiveness of our proposed simple network. With the help of the diffusion process, the AGROL diffusion model 600 further improved the performance of the MLP-based network 500 and surpassed all previous techniques. Moreover, the AGROL diffusion model 600 significantly reduced the Jitter error, which means that the generated motion was much smoother compared to the others. Some examples are visualized in FIG. 7 and FIG. 8. FIG. 7 shows a comparison of the reconstruction error between the AGROL diffusion model 600 and AvatarPoser. In FIG. 8, by visualizing the pose trajectories, a comparison is shown of the smoothness between the AGROL diffusion model 600 and AvatarPoser.

FIG. 7. shows a qualitative comparison between the AGROL diffusion model 600 of some embodiments (lower) and AvatarPoser (upper) on test sequences from the AMASS dataset. The predicted skeleton and human body meshes are visualized in the figures. The skeletons in green denote the motion predicted using the AGROL diffusion model 600. The skeletons in red denote the motion predicted using AvatarPoser. The skeletons in blue denote the ground truth motion. As shown in the figure, the predicted motion of the AGROL diffusion model 600 is more accurate compared to the predicted motion of AvatarPoser.

FIG. 8 shows a visualization of motion trajectory between the AGROL diffusion model 600 of some embodiments and AvatarPoser. The trajectories of the predicted motion are visualized in the figures. The images on the left show the ground truth motion with blue skeletons. The images in the middle show the predicted motion of the AGROL diffusion model 600 with green skeletons. The images on the right show the predicted motion of AvatarPoser with red skeletons. The light purple vectors in the figures denote the velocity vector of each joint. By visualizing the trajectories of the motion, the jittering issues and foot sliding issues can be better viewed from the figures. Smooth motion tends to have regular pose trajectories with the velocity vector of each joint changing steadily. The density of the pose trajectories changes along with the walking speed, as the trajectories become denser when the person slows down. Thus, if there is no foot sliding, the change of density in pose trajectories should occasionally be seen.

### Ablation Studies

The MLP-based network 500 of some embodiments was compared with other networks using the diffusion model 600 described above, to show the effectiveness of the MLP-based network 500. Time step embedding was also ablated for the diffusion model 600, with different strategies to add time step embedding. The influence of extra losses and the number of sampling steps we used during the inference were also studied.

### Architecture

To validate the effectiveness of the MLP-based network 500 in a diffusion model setup, the MLP-based network 500 was replaced with other types of networks and results compared. Two architectures were considered, a network from AvatarPoser and a transformer network. In the case of transformer networks, instead of repetitively injecting the time positional embedding to every block, the time positional embedding was concatenated with the input features x̅^{1:N} and p̅^{1:N} before being fed to the network. The same strategy was applied to the network of AvatarPoser as this model also uses transformer blocks in the early stage. To establish a fair comparison to the AvatarPoser architecture, two versions of this model were trained, one using original settings and the other with more transformer layers to obtain a comparable size to the proposed diffusion model 600. The same experiment was also performed for the transformer network. As shown in Table 3, the proposed MLP-based network 500 of some embodiments achieved superior results compared to other networks when trained in the diffusion fashion.

TABLE 3

| Technique | #Params | MPJRE | MPJPE | MPJVE | Hand PE | Upper PE | Lower PE | Root PE | Root RE | Jitter |
|---|---|---|---|---|---|---|---|---|---|---|
| AvatarPoser | 2.89M | 4.22 | 6.99 | 30.52 | 2.40 | 2.96 | 12.80 | 2.40 | 21.39 | 9.52 |
| AvatarPoser-Large | 7.63M | 2.91 | 4.40 | 24.91 | 2.24 | 2.14 | 7.66 | 3.73 | 19.77 | 9.94 |
| Transformer | 7.03M | 3.15 | 4.95 | 23.21 | 3.70 | 2.67 | 8.25 | 4.22 | 20.26 | 6.43 |
| AGRoL (Ours) - pred noise | 7.51M | 5.43 | 9.02 | 31.18 | 4.98 | 4.19 | 15.99 | 8.63 | 22.79 | 9.80 |
| AGRoL (Ours) | 7.51M | 2.71 | 4.11 | 21.61 | 2.26 | 2.9 | 7.04 | 3.53 | 19.54 | 7.27 |

Table 3 summarizes the ablation study of network architectures in the diffusion model 600 of some embodiments. The MLP-based network 500 was replaced with other networks and trained in the diffusion model fashion with the same hyperparameters. In this example, the MLP-based network 500 outperformed all other networks on most of the metrics. The AvatarPoser-Large denotes the network with the same architecture as AvatarPoser but with more transformer layers. The best results are in bold, and the second-best results are underlined.

### Diffusion Time Step Embedding

Some embodiments of the diffusion model 600 used step embedding to indicate the noising step t during the diffusion process. In this example, sinusoidal position embedding was used as the time step embedding. The results of the AGROL diffusion model 600 are shown without time step embedding in Table 4. The diffusion model 600 may still achieve decent performance on metrics related to position errors and rotation errors, while the performance on metrics related to velocity errors (MPJVE and Jitter) may be severely degraded. Since the time step embedding is missing, the diffusion model 600 may not know which step it locates, and thus may not be able to denoise properly.

In this example, three strategies were ablated for applying the time step embedding in the diffusion model 600: Add, Concat, and RepIn. In contrast to the RepIn, which repetitively passes the time step embedding through a linear layer and injects them into every block of the MLP network, in Add and Concat, the time step embedding is only used once at the beginning of the network. Here, the time step embedding was first passed through a fully connected layer and a SiLU activation layer to obtain a latent feature u∈ [symbol] ^{1×K} before being fed to the network. In particular, Add sums up the u and the input features x̅^{1:N} and p̅^{1:N}, the output of the network is therefore \hat{x}ₜ^{1:N}=f_{θ}(Concat(x̅^{1:N},p̅^{1:N})+u). Concat concatenates the u with the input features x̅^{1:N} and p̅^{1:N}, thus, the output of the network is \hat{x}ₜ^{1:N}=f_{θ}(Concat(x̅^{1:N}, p̅^{1:N}, u)). RepIn represents a strategy for adding the time step embedding. Specifically, for each block of the MLP network, the time step embedding was projected separately through a fully connected layer and a SiLU activation layer, then the obtained feature uᵢ, i∈[0, . . . M] was added to the input features of its correspondent block. As shown in Table 4, this strategy may largely improve the velocity-related metrics and alleviate the jittering issues to generate smooth motion.

TABLE 4

| Technique | MPJRE | MPJPE | MPJVE | Hand PE | Upper PE | Lower PE | Root PE | Root RE | Jitter |
|---|---|---|---|---|---|---|---|---|---|
| w/o Time | 2.74 | 4.05 | 25.47 | 2.27 | 2.8 | 6.89 | 3.43 | 19.39 | 15.23 |
| Add | 2.85 | 4.39 | 26.17 | 2.30 | 2.15 | 7.63 | 3.75 | 19.62 | 15.02 |
| Concat | 2.77 | 4.15 | 24.56 | 2.32 | 2.8 | 7.13 | 3.57 | 19.63 | 13.10 |
| RepIn (Ours) | 2.71 | 4.11 | 21.61 | 2.26 | 2.9 | 7.04 | 3.53 | 19.54 | 7.27 |

Table 4 summarizes ablation of the time step embedding according to some embodiments. w/o Time denotes the results of AGROL without time step embedding. Add sums up the features from time step embedding with the input features. Concat concatenates the features from time step embedding with the input features. In Add and Concat, the time step embedding is only fed once at the top of the network. RepIn (Repetitive Injection) denotes a strategy to inject the time step embedding into every block of the network. As shown in the table, the time step embedding mainly affects the MPJVE and Jitter metrics. Without time step embedding, or adding the time step embedding improperly, may result in high errors for velocity-related metrics, causing severe jittering issues.

### Additional Losses

In addition to [symbol] _{dm}, three other geometric losses were explored during the training:

$$\\ \begin{matrix}{ℒ}_{pos} = \frac{1}{N} {\sum }_{i = 1}^{N} {‖ FK ( {𝒴}_{0}^{{}_{} i} ) - FK ( \hat{x} {}_{0}^{{}_{} i} ) ‖}_{2}^{2} & ( 8 )\end{matrix}$$

$$\\ \begin{matrix}{ℒ}_{vel} = \frac{1}{N - 1} {\sum }_{i = 1}^{N - 1} {‖ ( FK ( {y}_{0}^{{}_{} i + 1} ) - FK ( \hat{x} {}_{0}^{{}_{} i} ) ) - ( FK ( \hat{x} {}_{0}^{{}_{} i + 1} ) - FK ( \hat{x} {}_{0}^{{}_{} i} ) ) ‖}_{2}^{2} & ( 9 )\end{matrix}$$

$$\\ \begin{matrix}{ℒ}_{foot} \frac{1}{N - 1} {\sum }_{i - 1}^{N - 1} {‖ ( FK ( {𝒴}_{0}^{{}_{} i} ) - FK ( \hat{x} {}_{0}^{{}_{} i} ) ) \cdot {m}_{i} ‖}_{2}^{2} & ( 10 )\end{matrix}$$

where FK( ) is the forward kinematics function which takes local human joint rotations as input and outputs these joint positions in the global coordinate space. [symbol] ₚₒₛ represents the position loss the of joints, [symbol] ᵥₑₗ represents the velocity loss of the joints in 3D space and [symbol] _{foot} represents the foot contact loss, which enforces static feet when there is no feet movement. [symbol] ᵢ∈{0,1} denotes the binary mask and equals to 0 when the feet joints have zero velocity.

In this example, the diffusion model 600 was trained with different combinations of extra losses, setting their weights equal to 1. The extra geometric losses did not bring additional performance to the diffusion model 600. The diffusion model 600 may achieve good results when trained solely with the denoising objective function Eq. (4). One reason that extra losses do not improve the performance of the AGROL diffusion model 600 may be due to the inner working of the reverse diffusion process, which doesn't interplay with extra geometrical losses without proper tuning.

TABLE 5

| [symbol] ₚₒₛ | [symbol] ᵥₑₗ | [symbol] _{foot} | MPJRE | MPJPE | MPJVE | Hand PE | Upper PE | Lower PE | Root PE | Root RE | Jitter |
|---|---|---|---|---|---|---|---|---|---|---|---|
| | | | 2.71 | 4.11 | 21.61 | 2.26 | 2.9 | 7.04 | 3.53 | 19.54 | 7.27 |
| | | ✓ | 2.88 | 4.42 | 23.41 | 2.40 | 2.19 | 7.64 | 3.78 | 19.74 | 9.20 |
| ✓ | | | 2.78 | 4.28 | 23.12 | 2.53 | 2.19 | 7.30 | 3.69 | 19.65 | 9.92 |
| ✓ | ✓ | | 2.78 | 4.28 | 23.30 | 2.55 | 2.20 | 7.30 | 3.68 | 19.60 | 10.16 |
| ✓ | ✓ | ✓ | 2.93 | 4.51 | 23.32 | 2.53 | 2.24 | 7.78 | 3.90 | 19.86 | 8.98 |

TABLE 6

| # Sampling Steps | MPJRE | MPJPE | MPJVE | Hand PE | Upper PE | Lower PE | Root PE | Root RE | Jitter |
|---|---|---|---|---|---|---|---|---|---|
| 2 | 3.21 | 5.21 | 22.91 | 3.02 | 2.56 | 9.04 | 4.60 | 20.30 | 6.90 |
| 5 | 2.71 | 4.11 | 21.61 | 2.26 | 2.9 | 7.04 | 3.53 | 19.54 | 7.27 |
| 10 | 2.73 | 4.10 | 22.49 | 2.28 | 2.9 | 7.00 | 3.50 | 19.62 | 7.51 |
| 100 | 2.89 | 4.33 | 26.26 | 2.46 | 2.20 | 7.41 | 3.72 | 19.85 | 9.64 |
| 1000 | 2.70 | 4.54 | 29.94 | 2.65 | 2.30 | 7.78 | 3.88 | 20.12 | 12.79 |

TABLE 7

| Technique | MPJRE | MPJPE | MPJVE | Hand PE | Upper PE | Lower PE | Root PE | Root RE | Jitter |
|---|---|---|---|---|---|---|---|---|---|
| AvatarPoser | 5.69 | 10.34 | 572.58 | 8.98 | 5.49 | 17.34 | 8.83 | 27.27 | 762.79 |
| MLP | 5.37 | 10.76 | 107.82 | 12.43 | 6.48 | 16.94 | 8.74 | 25.38 | 92.51 |
| Transformer | 4.47 | 8.69 | 137.69 | 7.61 | 5.43 | 13.38 | 10.15 | 21.37 | 147.9 |
| AGRoL (Ours) | 4.20 | 6.54 | 97.34 | 5.73 | 4.10 | 10.8 | 6.55 | 20.97 | 32.78 |

Table 5 summarizes ablation of the additional losses used during training of the diffusion model 600, according to some embodiments.

Table 6 summarizes ablation of the number of sampling steps during inference, according to some embodiments. The input and output length is fixed to N=196.

Table 7 summarizes the robustness of the diffusion model 600 to joints tracking loss, according to some embodiments. Different techniques were evaluated by randomly masking a portion (10%) of input frames during the inference on the AMASS dataset. Each technique was tested 5 times and the average results were taken. In this example, the AGROL diffusion model 600 achieved the best performance among all the techniques, which shows the robustness against joint tracking loss.

### Number of Sampling Steps During Inference

In this example, the number of sampling steps that were used during the inference were ablated. An embodiment of the diffusion model 600 was used that was trained with 1000 sampling steps and tested with a subset of steps in the diffusion process. Five DDIM sampling steps were used, allowing the diffusion model 600 to achieve superior performance on most of the metrics while being fast.

### Robustness to Tracking Loss

In this example, the robustness of some embodiments of the diffusion model 600 was studied against tracking loss of the input joints. In practice, it is a common problem in VR applications that the joint tracking signal is lost on some frame, due to hands or controllers going out of the field of view, creating temporal sparsity in the inputs. The performance of all available techniques on tracking loss was evaluated by randomly masking a portion of input frames during the inference. The results are shown in Table 7. The performance of other techniques was largely degraded, which indicated that they were not robust against the tracking loss problem. In comparison, the accuracy of the diffusion model 600 was less degraded, which indicates that the diffusion model 600 can accurately model motion given highly sparse tracking inputs.

### Inference Speed

The AGROL diffusion model 600 of some embodiments achieves real-time inference speed due to a lightweight architecture combined with DDIM sampling. A single AGROL generation, that runs 5 DDIM sampling steps, produces 196 output frames in 35 ms on a single NVIDIA V100 GPU. The predictive MLP-based diffusion model 600 takes 196 frames as input and predicts a final result of 196 frames in a single forward pass. It is even faster and requires only 6 ms on a single NVIDIA V100 GPU.

### Conclusion and Limitations

Some embodiments provide an MLP-based architecture with building blocks to achieve competitive performance on the full body motion synthesis task. Some embodiments provide AGROL, a conditional diffusion model 600 for full body motion synthesis based on sparse tracking signal. The AGROL diffusion model 600 leverages a simple and yet efficient conditioning scheme for structured human motion data. It is shown herein that such a lightweight diffusion-based model generates realistic and smooth human motions while achieving real-time inference speed, making it suitable for online AR/VR applications.

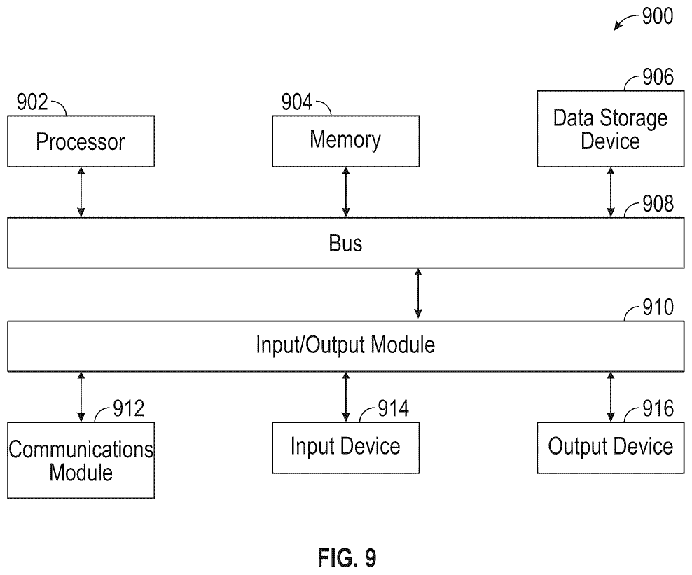

FIG. 9 is a block diagram illustrating an exemplary computer system 900 with which aspects of the subject technology can be implemented. In certain aspects, the computer system 900 may be implemented using hardware or a combination of software and hardware, either in a dedicated server, integrated into another entity, or distributed across multiple entities.

Computer system 900 (e.g., server and/or client) includes a bus 908 or other communication mechanism for communicating information, and a processor 902 coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, i.e., one or more modules of computer program instructions encoded on a computer-readable medium for execution by, or to control the operation of, the computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. The input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, the input/output module 910 is configured to connect to a plurality of devices, such as an input device 914 and/or an output device 916. Exemplary input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 916 include display devices such as an LCD (liquid crystal display) monitor, for displaying information to the user.

According to one aspect of the present disclosure, systems for full body motion tracking (e.g., the above-described system 200) can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in the main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires that comprise bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 900 reads application data and provides an application, information may be read from the application data and stored in a memory device, such as the memory 904. Additionally, data from the memory 904 servers accessed via a network, the bus 908, or the data storage 906 may be read and loaded into the memory 904. Although data is described as being found in the memory 904, it will be understood that data does not have to be stored in the memory 904 and may be stored in other memory accessible to the processor 902 or distributed among several media, such as the data storage 906.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for full body motion tracking, comprising:
receiving tracking signals from a plurality of sensors associated with an upper body of a person;
based on the tracking signals, determining motion features and joint features;
training a diffusion model, the diffusion model comprising a multi-layer perceptron (MLP) network;
generating a plurality of inputs to the trained diffusion model, the plurality of inputs comprising the motion features and the joint features; and
providing the plurality of inputs to the trained diffusion model to generate a plurality of outputs,
wherein the plurality of outputs comprise sequences of full body poses, and the sequences of full body poses comprise upper body poses and lower body poses.

2. The method of claim 1, further comprising generating intermediate features from the motion features and the joint features, wherein the plurality of inputs to the diffusion model comprise the intermediate features, and the sequences of full body poses are generated based on the intermediate features.

3. The method of claim 2, wherein generating the plurality of outputs comprises generating the plurality of outputs from the MLP network based on the intermediate features.

4. The method of claim 1, wherein the plurality of outputs comprise positions of a lower body of the person, the method further comprising estimating the positions of the lower body based on the sequences of full body poses.

5. The method of claim 1, wherein the MLP network comprises a plurality of blocks, the method further comprising providing a timestep embedding to each block in the plurality of blocks.

6. The method of claim 5, wherein the timestep embedding is provided to each block in the plurality of blocks through a fully connected layer and a sigmoid linear unit activation layer.

7. The method of claim 5, wherein each block in the plurality of blocks comprises a convolutional layer and a fully connected layer.

8. The method of claim 7, wherein each block in the plurality of blocks further comprises a sigmoid linear unit activation layer and a layer normalization.

9. The method of claim 1, wherein the plurality of sensors are inertial measurement units (IMUs).

10. The method of claim 1, wherein the plurality of sensors consist of a first sensor mounted in a first handheld device, a second sensor mounted in a second handheld device, and a third sensor mounted in a head mounted device (HMD), and the tracking signals comprise a first orientation and a first translation of the first handheld device, a second orientation and a second translation of the second handheld device, and a third orientation and a third translation of the head mounted device.

11. A non-transitory computer-readable medium storing a program for full body motion tracking, which when executed by a computer, configures the computer to:
receive tracking signals from a plurality of sensors associated with an upper body of a person;
based on the tracking signals, determine motion features and joint features;
train a diffusion model, the diffusion model comprising a multi-layer perceptron (MLP) network;
generate a plurality of inputs to the trained diffusion model, the plurality of inputs comprising the motion features and the joint features; and
provide the plurality of inputs to the trained diffusion model to generate a plurality of outputs,
wherein the plurality of outputs comprise sequences of full body poses, and the sequences of full body poses comprise upper body poses and lower body poses.

12. The non-transitory computer-readable medium of claim 11, wherein the program, when executed by the computer, further configures the computer to:
generate intermediate features from the motion features and the joint features,
wherein the plurality of inputs to the diffusion model comprise the intermediate features, and the sequences of full body poses are generated based on the intermediate features, and
wherein generating the plurality of outputs comprises generating the plurality of outputs from the MLP network based on the intermediate features.

13. The non-transitory computer-readable medium of claim 11, wherein the plurality of outputs comprise positions of a lower body of the person, the MLP network comprises a plurality of blocks, and the program, when executed by the computer, further configures the computer to:
estimate the positions of the lower body based on the sequences of full body poses; and
provide a timestep embedding to each block in the plurality of blocks, wherein the timestep embedding is provided to each block in the plurality of blocks through a fully connected layer and a sigmoid linear unit activation layer.

14. The non-transitory computer-readable medium of claim 13, wherein each block in the plurality of blocks comprises a convolutional layer, a fully connected layer, a sigmoid linear unit activation layer, and a layer normalization.

15. The non-transitory computer-readable medium of claim 11, wherein the plurality of sensors are inertial measurement units (IMUs).

16. The non-transitory computer-readable medium of claim 11, wherein the plurality of sensors consist of a first sensor mounted in a first handheld device, a second sensor mounted in a second handheld device, and a third sensor mounted in a head mounted device (HMD), and the tracking signals comprise a first orientation and a first translation of the first handheld device, a second orientation and a second translation of the second handheld device, and a third orientation and a third translation of the head mounted device.

17. A system for full body motion tracking, comprising:
a processor; and
a non-transitory computer readable medium storing a set of instructions, which when executed by the processor, configure the processor to:
receive tracking signals from a plurality of sensors associated with an upper body of a person;
based on the tracking signals, determine motion features and joint features;
train a diffusion model, the diffusion model comprising a multi-layer perceptron (MLP) network;
generate a plurality of inputs to the trained diffusion model, the plurality of inputs comprising the motion features and the joint features; and
provide the plurality of inputs to the trained diffusion model to generate a plurality of outputs,
wherein the plurality of outputs comprise sequences of full body poses, and the sequences of full body poses comprise upper body poses and lower body poses.

18. The system of claim 17, wherein the instructions, when executed by the processor, further configure the processor to:
generate intermediate features from the motion features and the joint features,
wherein the plurality of inputs to the diffusion model comprise the intermediate features, and the sequences of full body poses are generated based on the intermediate features, and
wherein generating the plurality of outputs comprises generating the plurality of outputs from the MLP network based on the intermediate features.

19. The system of claim 17, wherein the plurality of outputs comprise positions of a lower body of the person, the MLP network comprises a plurality of blocks, and the instructions, when executed by the processor, further configure the processor to:
estimate the positions of the lower body based on the sequences of full body poses; and
provide a timestep embedding to each block in the plurality of blocks, wherein the timestep embedding is provided to each block in the plurality of blocks through a fully connected layer and a sigmoid linear unit activation layer,
wherein each block in the plurality of blocks comprises a convolutional layer, a fully connected layer, a sigmoid linear unit activation layer, and a layer normalization.

20. The system of claim 17, wherein the plurality of sensors are inertial measurement units (IMUs), the plurality of sensors consist of a first sensor mounted in a first handheld device, a second sensor mounted in a second handheld device, and a third sensor mounted in a head mounted device (HMD), and the tracking signals comprise a first orientation and a first translation of the first handheld device, a second orientation and a second translation of the second handheld device, and a third orientation and a third translation of the head mounted device.
